(19) United States
(12) Patent Application Publication
(10) Pub. No.: US 2025/0018784 A1
(43) Pub. Date: Jan. 16, 2025

(54) SUPPORT MECHANISM OF RESERVOIR TANK FOR VEHICLE

(71) Applicant: TOYOTA JIDOSHA KABUSHIKI KAISHA, Toyota-shi (JP)

(72) Inventor: Yuya NOJI, Toyota-shi (JP)

(73) Assignee: TOYOTA JIDOSHA KABUSHIKI KAISHA, Toyota-shi (JP)

(21) Appl. No.: 18/442,510

(22) Filed: Feb. 15, 2024

(30) Foreign Application Priority Data
Jul. 11, 2023 (JP) 2023-113623

(51) Int. Cl. B60K 11/02

(52) U.S. Cl. CPC B60K 11/02

(57) ABSTRACT

The support mechanism of the vehicle reservoir tank includes a reservoir tank and a displacement device. The coolant is stored in the reservoir tank. Further, the reservoir tank is connected to a cooling circuit. The displacement device includes a V actuator and an H actuator. The V actuator and the H actuator make the attitude of the reservoir tank variable.

### CROSS-REFERENCE TO RELATED APPLICATION

This application claims priority to Japanese Patent Application No. 2023-113623 filed on Jul. 11, 2023, incorporated herein by reference in its entirety.

### BACKGROUND

### 1. Technical Field

The present specification discloses a support mechanism of a reservoir tank for a vehicle.

### 2. Description of Related Art

A reservoir tank is connected to a cooling circuit of a vehicle. Coolant flowing through the cooling circuit exhibits increased volume at high temperatures. As the volume of the coolant increases, internal pressure of the cooling circuit increases. As the internal pressure of the cooling circuit increases, the coolant flows from the cooling circuit into the reservoir tank. As a result, overpressure of the cooling circuit is suppressed.

When the temperature of the coolant decreases, the volume of the coolant decreases. In conjunction with this, the internal pressure of the coolant circuit decreases. As the internal pressure of the cooling circuit decreases, the coolant is supplied from the reservoir tank to the coolant circuit. This suppresses excessive decompression of the cooling circuit.

For example, coolant is stored in the reservoir tank, in a range of 20% or more and 50% or less by volume. That is to say, the reservoir tank contains air therein, besides the coolant. When air bubbles become intermingled in the coolant flowing out from the reservoir tank to the coolant circuit, cooling efficiency deteriorates. In order to suppress air bubbles from becoming intermingled, in Japanese Unexamined Patent Application Publication No. 2020-159318 (JP 2020-159318 A), for example, inside of the reservoir tank is divided into a plurality of chambers. A first chamber is connected to an inlet port. A height of a ceiling of the first chamber is set to be lower than a liquid level of the reservoir tank. In Japanese Unexamined Patent Application Publication No. 2015-28336 (JP 2015-28336 A), a gas-liquid separation chamber is provided in a reservoir tank.

Japanese Unexamined Patent Application Publication No. 6-99711 (JP 6-99711 A) discloses fluid active suspension. This suspension includes an air spring and a reservoir tank. The amount of air supplied from the reservoir tank to the air spring is controlled by a valve. In this suspension, the supply amount and the discharge amount of air are determined so as to cancel up-down acceleration generated in the suspension.

### SUMMARY

Now, acceleration in a direction different from a gravitational direction is generated in the vehicle during high-speed turning or during rapid acceleration/deceleration. For example, acceleration in a horizontal direction is generated in the vehicle. At this time, a liquid level 103 of coolant 102 becomes deviated, such as illustrated in transition from an upper illustration to a lower illustration in FIG. 10. When part of a coolant port 101 is exposed from the liquid level 103, air bubbles may become intermingled.

Accordingly, the present specification discloses a support mechanism of a reservoir tank for a vehicle. When acceleration in a direction different from the gravitational direction is generated in the vehicle, this support mechanism can suppress air bubbles from becoming intermingled in the cooling circuit.

The present specification discloses a support mechanism of a reservoir tank for a vehicle.

The support mechanism includes
the reservoir tank in which a coolant is stored, and that is connected to a cooling circuit, and
a displacement device that is configured to vary an attitude of the reservoir tank.

According to the above configuration, the attitude of the reservoir tank can be changed in accordance with an acceleration vector generated in the vehicle.

In addition, in the above configuration, the support mechanism may further include
a map data processor that sets a travel route of the vehicle on map data,
a positioning device that acquires a position of the vehicle, and
a controller that controls the displacement device.

The controller may include an acceleration predictor.

The acceleration predictor may be configured to predict an acceleration vector generated with respect to the vehicle, based on an acceleration or deceleration operation of the vehicle, a vehicle speed of the vehicle, and road information ahead of the vehicle along the travel route.

Also, the controller may be further configured to find an operation amount of the displacement device, based on the acceleration vector that is predicted.

According to the above configuration, the acceleration vector generated in the vehicle is calculated in advance. Displacing the attitude of the reservoir tank based on a predicted value of the acceleration vector suppresses intermingling of air bubbles into the cooling circuit.

Also, in the support mechanism,
the displacement device may include
a first actuator that is pivotable about a vertical axis, and
a second actuator that is pivotable about an axis orthogonal to the vertical axis.

According to the above configuration, the reservoir tank can be displaced on a spherical locus.

Also, in the support mechanism,
a bottom wall of the reservoir tank may be provided with a port that is an inlet and outlet of the coolant, and
the displacement device may be configured to displace the attitude of the reservoir tank such that the acceleration vector that is predicted and the bottom wall of the reservoir tank are orthogonal.

According to the above configuration, when acceleration is generated in the vehicle, the liquid level of the coolant is maintained in parallel to the bottom wall of the reservoir tank.

According to the support mechanism of the reservoir tank for the vehicle of the present specification, when acceleration in a direction different from the gravitational direction is generated in the vehicle, air bubbles can be suppressed from becoming intermingled into the cooling circuit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a cooling circuit mounted on a vehicle;

FIG. 2 is an enlarged perspective view of the periphery of the reservoir tank;

FIG. 3 is a system diagram illustrating a support mechanism of a reservoir tank according to the present embodiment;

FIG. 4 is a diagram illustrating a hardware configuration of a reservoir tank attitude controller;

FIG. 5 is a plan view illustrating the process of predicting the so-called lateral G occurring in a vehicle;

FIG. 6 is a diagram for explaining the synthesis of acceleration vectors;

FIG. 7 is a perspective view illustrating an exemplary method of controlling the attitude of the reservoir tank based on the acceleration vector synthesized in FIG. 6;

FIG. 8 is a diagram for explaining another example of the synthesis of acceleration vectors;

FIG. 9 is a perspective view showing an embodiment of attitude control of the reservoir tank based on the acceleration vector synthesized in FIG. 8; and

FIG. 10 is a diagram illustrating a conventional example when air bubbles enter a cooling circuit.

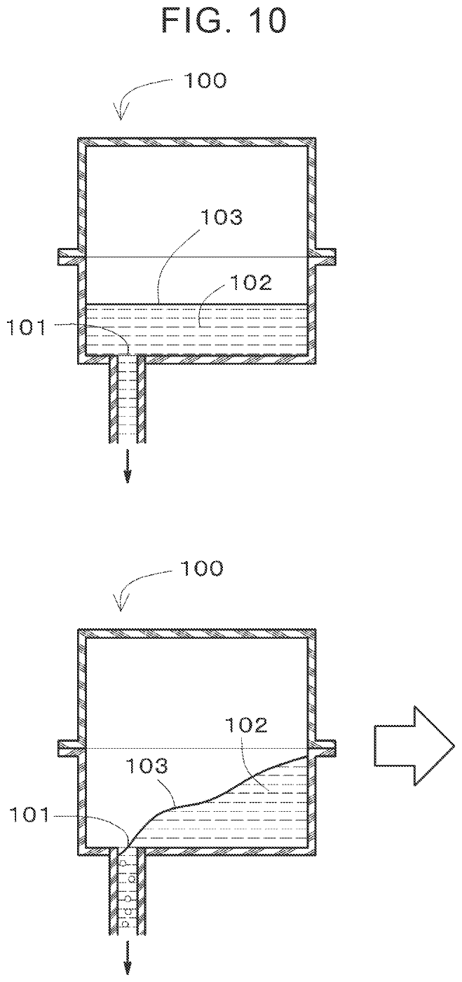

### DETAILED DESCRIPTION OF EMBODIMENTS

Hereinafter, a support mechanism of a vehicle reservoir tank according to an embodiment will be described with reference to the drawings. The shapes, materials, numbers, and numerical values described below are illustrative examples. These elements can be appropriately changed according to the specifications of the support mechanism of the vehicle reservoir tank. In addition, in the following, the same reference numerals are given to the same elements in all the drawings.

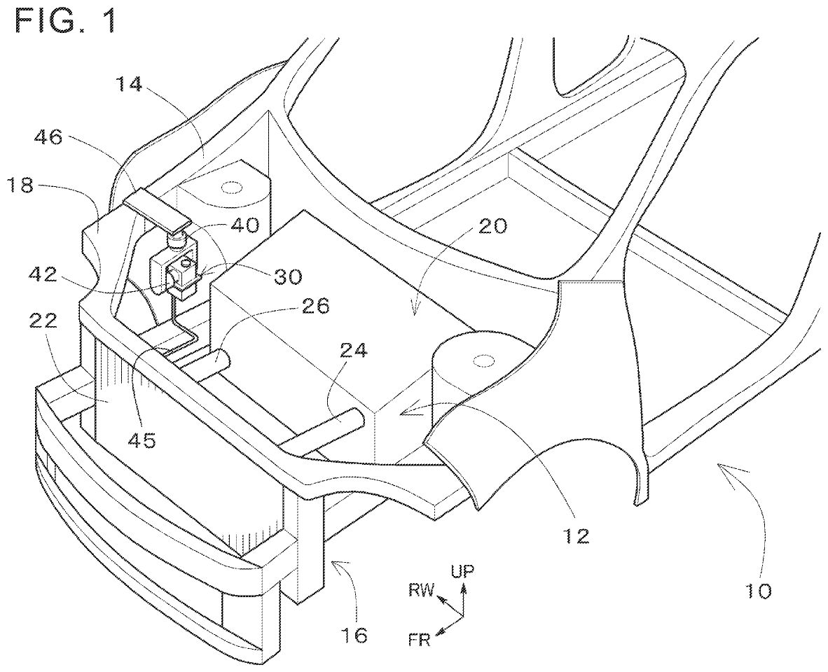

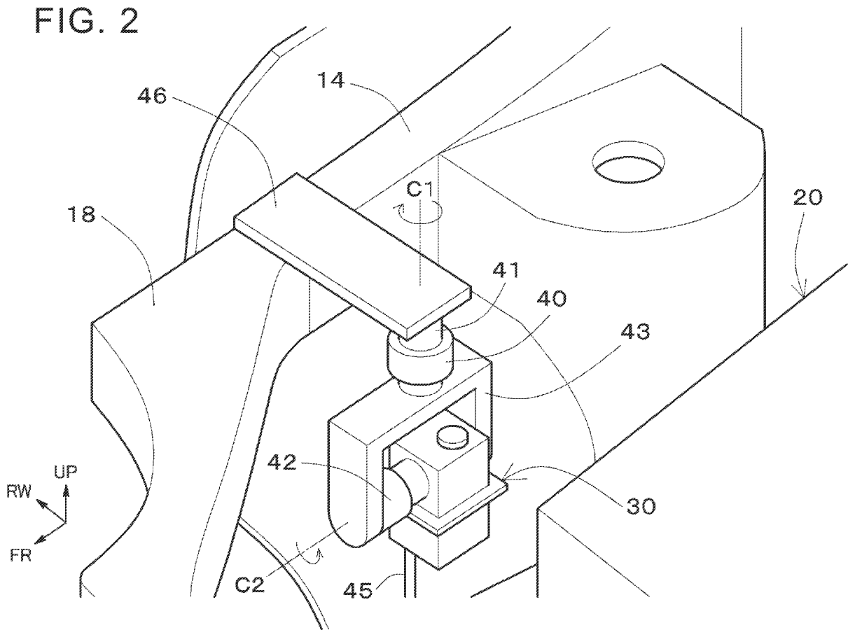

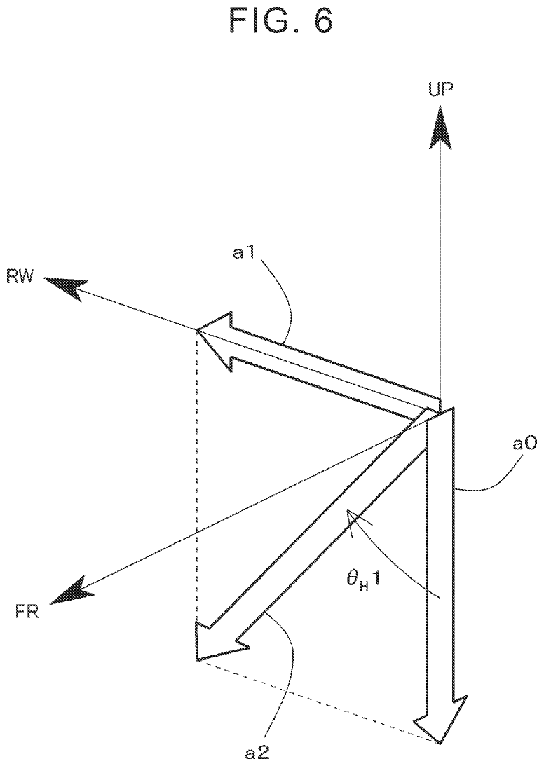

In FIG. 1, FIG. 2, FIG. 6 to FIG. 9, a Cartesian coordinate system is used to represent the positions and orientations of the respective configurations. The Cartesian coordinate system includes a FR axis, a RW axis, and a UP axis. FR shaft is a vehicle-front-rear axis. RW is a cross-sectional axis. UP shaft is a vehicle-vertical shaft. FR shaft has a forward direction in front of the vehicle. The positive direction of the RW axis is the right side of the vehicle. The upper side of UP shaft is defined as a positive direction.

### Cooling Circuit

In FIG. 1, a front part of the vehicle 10 is illustrated. In FIG. 1, a monocoque body shell is illustrated. A powertrain 20 is disposed in the engine compartment 12. The powertrain 20 includes a drive source and a transmission. The drive source is, for example, an internal combustion engine or a rotary electric machine. The powertrain 20 further includes a high voltage circuit element. The high-voltage circuit element controls the rotary electric machine. For example, inverters and DC/DC converters are arranged in the powertrain 20 as high-voltage circuitry. In addition, a water jacket (not shown) is formed in the powertrain 20. The water jacket is a flow path of the coolant. A water jacket is disposed in the vicinity of the drive source and the high voltage circuit element. The cooling target is not limited to a drive source or a high-voltage circuit element. For example, a vehicle-mounted component that generates heat, such as a battery, may be included as a cooling target.

A radiator 22 is disposed in front of the engine compartment 12. For example, the radiator 22 is supported by the radiator support 16. The radiator 22 and the powertrain 20 are connected by an inlet pipe 24 and an outlet pipe 26.

The coolant cooled by the radiator 22 is sent from the inlet pipe 24 to the powertrain 20 by a water pump (not shown). The cooled coolant is returned from the outlet pipe 26 to the radiator 22.

Further, the radiator 22 is connected to the reservoir tank 30. For example, the radiator 22 and the reservoir tank 30 are connected by a hose 45. As will be described later, the reservoir tank 30 is displaced by the V actuator 40 and the H actuator 42 which are displacement devices. In order to be able to follow this displacement, the hose 45 is made of a flexible material such as rubber. The length of the hose 45 is determined with sufficient margin for the shortest distance from the reservoir tank 30 to the radiator 22.

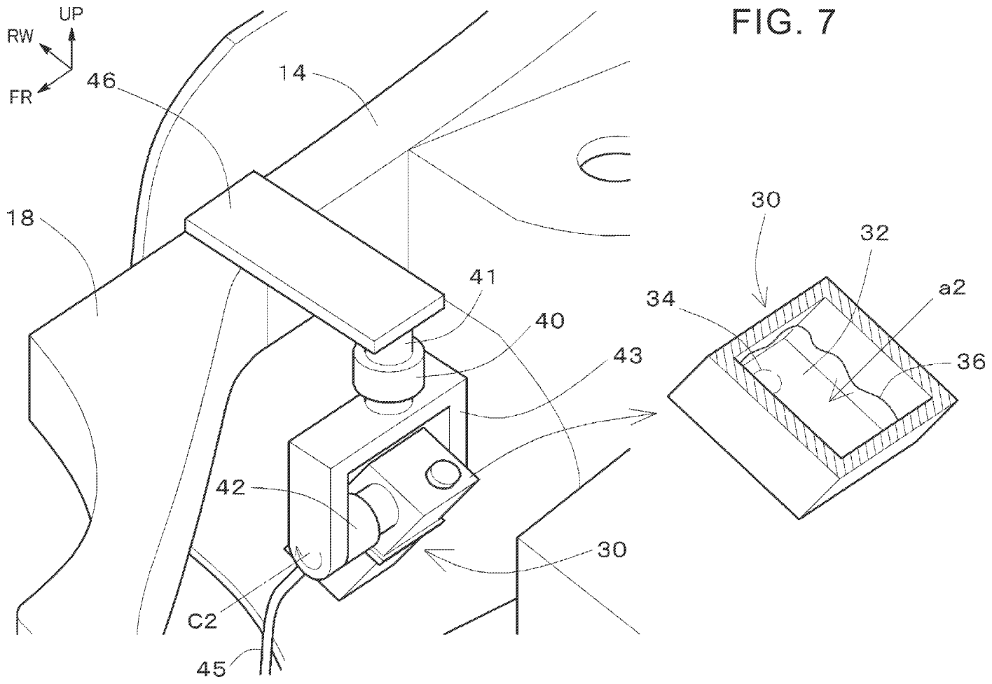

The coolant 36 (see FIG. 7) is stored in the reservoir tank 30. The reservoir tank 30 is, for example, a rectangular parallelepiped container. A port 34 is opened in the bottom wall 32 of the reservoir tank 30. The port 34 is an entrance and exit of the coolant 36. The upper end of the hose 45 is connected to the port 34. The reservoir tank 30 is connected to the cooling circuit via the hose 45. Note that the reservoir tank 30 is not limited to a rectangular parallelepiped. For example, a three-dimensional shape including a cylindrical shape or an uneven surface may be used.

In the vehicle 10, the cooling circuit includes a powertrain 20 and a radiator 22. In addition, an inlet pipe 24 and an outlet pipe 26 connecting these devices are included in the cooling circuit.

The coolant 36 is a so-called coolant liquid. The coolant liquid is mainly composed of a liquid having a low melting point such as ethylene glycol. When the temperature of the coolant in the cooling circuit increases, the volume of the coolant 36 increases. As the volume of the coolant 36 increases, the internal pressure of the cooling circuit increases. At this time, a part of the coolant 36 flows into the reservoir tank 30 via the hose 45. As a result, the overpressure of the cooling circuit is suppressed. The coolant 36 is not limited to the coolant liquid. For example, the coolant 36 includes a liquid such as oil.

When the temperature of the coolant 36 in the cooling circuit decreases, the volume of the coolant 36 decreases. As the volume of the coolant 36 decreases, the internal pressure of the cooling circuit decreases. At this time, a part of the coolant 36 flows into the radiator 22 via the hose 45. This suppresses excessive decompression of the cooling circuit.

When the coolant is sent from the reservoir tank 30 to the radiator 22, air bubbles may be mixed into the hose 45. For example, when a so-called lateral G occurs in the vehicle 10 and the liquid level of the coolant 36 is deviated, bubbles may be mixed into the hose 45. The lateral G refers to acceleration in the vehicle width direction.

Therefore, a support mechanism of the reservoir tank 30 is disposed in the vehicle 10. As will be described later, acceleration in a direction different from the gravitational direction is input to the vehicle 10 during a curve travel or the like. In preparation for this, the displacement device (the V actuator 40 and the H actuator 42) changes the posture of the reservoir tank 30. As a result, air bubbles can be suppressed from entering the cooling circuit.

### Support of Reservoir Tank

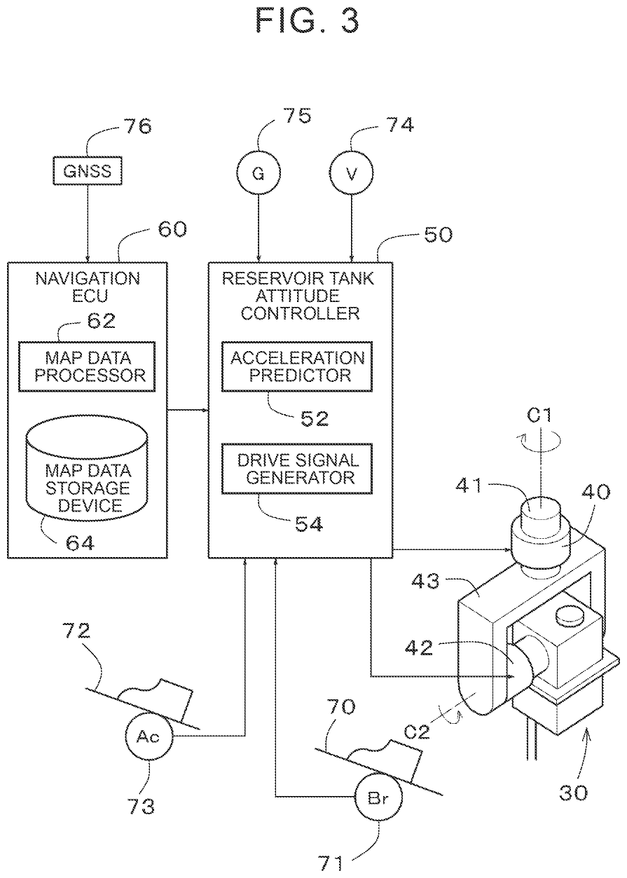

FIG. 2 is a diagram illustrating a structure around the reservoir tank 30. Referring to FIG. 2, the support mechanism of the reservoir tank 30 according to the present embodiment includes the reservoir tank 30, the V actuator 40, the H actuator 42, the rod 41, the arm 43, and the bracket 46. Referring to FIG. 3, the support mechanism includes a reservoir tank attitude controller 50, a navigation ECU 60, a brake sensor 71, an accelerator sensor 73, a vehicle speed sensor 74, an acceleration sensor 75, and a positioning device 76.

Referring to FIG. 2, the reservoir tank 30 is supported by the bracket 46, the rod 41, and the arm 43. The bracket 46 is fixed to the vehicle body. For example, the bracket 46 is supported by a skeletal component of the vehicle. For example, the bracket 46 is supported by the inside panel 14 and the upper frame 18. For example, the bracket 46 is fastened to the inside panel 14 and the upper frame 18 by welding or bolt fastening.

An outer end portion of the bracket 46 in the vehicle width direction is supported by the inside panel 14 and the upper frame 18. An inner end portion of the bracket 46 in the vehicle width direction is connected to an upper end of the rod 41. The rod 41 is provided with a V-actuator 40. The V-actuator 40 and the H-actuator 42 are also collectively referred to as displacement devices. This displacement device makes the attitude of the reservoir tank 30 variable.

The V-actuator 40 is pivotable about a vertical axis C1 as a rotational axis. Hereinafter, the V-actuator 40 is also referred to as a “first actuator” as appropriate. For example, the V-actuator 40 includes a servo motor. When the V-actuator 40 rotates by 360° or more, the hose 45 is twisted. Therefore, the operating angle of the V-actuator 40 is limited to, for example, less than 360°.

For example, as shown in FIG. 2, the longitudinal direction of the arm 43 is parallel to the vehicle-front-rear axis (FR axis). The rotation angle of the V actuator 40 at this time is set to 0°.

An arm 43 is connected below the V-actuator 40. The arm 43 is C-shaped in a side view (RW axis view). The H actuator 42 and the reservoir tank 30 are connected to the lower end of the arm 43.

The H actuator 42 is pivotable about the rotation axis C2. The rotation axis C2 is perpendicular to the vertical axis C1. For example, the rotation axis C2 extends horizontally. Hereinafter, the H actuator 42 is also referred to as a “second actuator” as appropriate. For example, the H actuator 42 includes a servo motor. Further, in order to suppress twisting of the hose 45, the operating angle of the H actuator 42 is limited to less than 360°.

For example, as illustrated in FIG. 2, the reservoir tank 30 is in a vertical position. At this time, the rotation angle of the H actuator 42 is set to 0°.

The reservoir tank 30 rotates together with the H actuator 42. The reservoir tank 30 rotates with respect to the arm 43. The reservoir tank 30 stores the coolant 36. The bottom wall 32 is then provided with a port 34. The port 34 is an entrance and exit of the coolant.

The V-actuator 40 rotates about the vertical axis C1. Further, the H actuator 42 rotates about the rotation axis C2. The two rotations are combined to displace the reservoir tank 30. For example, the trajectory of the reservoir tank 30 is such that it moves on a spherical surface.

An encoder (not shown) may be provided in each of the V actuator 40 and the H actuator 42. The encoder detects the absolute position of the V actuator 40 and the H actuator 42 within one rotation. For example, when the resolution of the V actuator 40 and the resolution of the H actuator 42 are 1000p/rev, the encoders have the same resolution. At this resolution, one revolution (1rev) is resolved to 1000 pulses.

### System Configuration of Support Mechanism

FIG. 3 is a diagram illustrating a configuration of a support mechanism of the reservoir tank 30. The support mechanism includes a reservoir tank attitude controller 50, a navigation ECU 60, a brake sensor 71, an accelerator sensor 73, a vehicle speed sensor 74, an acceleration sensor 75, and a positioning device 76.

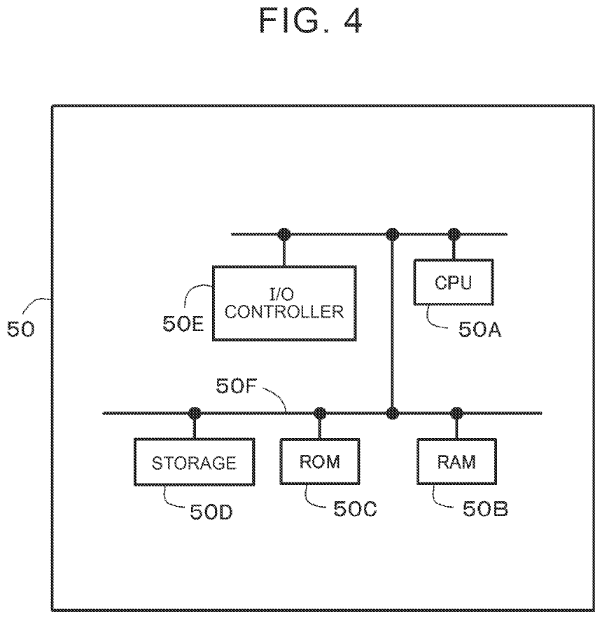

The reservoir tank attitude controller 50 controls the displacement device (the V actuator 40 and the H actuator 42). The reservoir tank attitude controller 50 is composed of a computer. FIG. 4 is a diagram illustrating a hardware configuration of the reservoir tank attitude controller 50. The reservoir tank attitude controller 50 includes an input/output controller 50E, CPU 50A, RAM 50B, ROM 50C and a storage device 50D. These devices are capable of communicating with each other via an internal bus 50F.

The input/output controller 50E receives signals outputted from various sensors of the vehicle 10. The input/output controller 50E transmits drive commands to the V actuator 40 and the H actuator 42. For example, the drive command is a pulse signal. For example, the input/output controller 50E includes a pulse signal output (CW_OUT) for commanding clockwise rotation and a pulse signal output (CCW_OUT) for commanding counterclockwise rotation. Further, the CW_OUT output and the CCW_OUT output are set for each of the V actuator 40 and the H actuator 42.

CPU 50A performs computations based on the signals received from the input/output controller 50E to generate drive commands to the displacement devices (i.e., the V-actuator 40 and the H-actuator 42). Storage elements such as RAM 50B, ROM 50C and storage device 50D store control programs, data detected by sensors, and the like.

CPU 50A executes the control program stored in the storage device 50D or ROM 50C. As a result, the reservoir tank attitude controller 50 has a functional block as illustrated in FIG. 3. That is, the reservoir tank attitude controller 50 includes an acceleration predictor 52 and a drive signal generator 54.

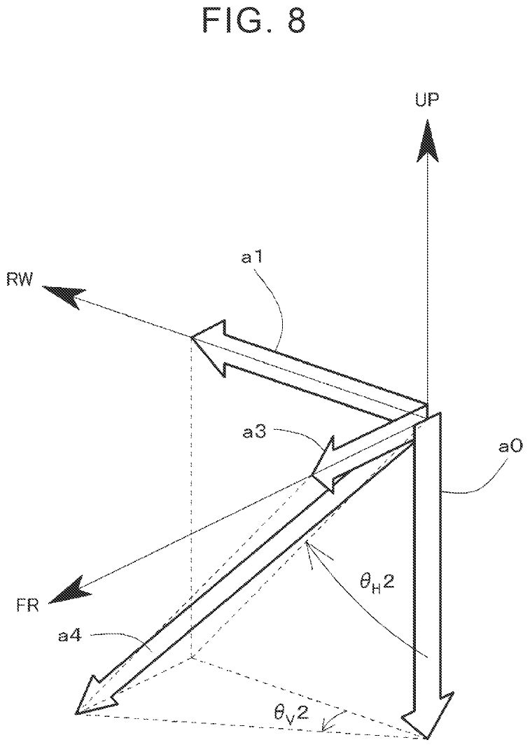

The acceleration predictor 52 cooperates with the navigation ECU 60 to calculate a predicted acceleration. This calculation process will be described later. The drive signal generator 54 generates a drive command based on the acceleration calculated by the acceleration predictor 52 and the current positions of the V actuator 40 and the H actuator 42. The displacement angles θv and θh will be described with FIG. 6 and FIG. 8, which will be described later.

The acceleration predictor 52 also receives signals from a plurality of on-board sensors. For example, the amount of depression of the brake pedal 70 is transmitted from the brake sensor 71 to the acceleration predictor 52. Further, the accelerator sensor 73 transmits the depression amount of the accelerator pedal 72 to the acceleration predictor 52. The speed value (vehicle speed) of the vehicle 10 is transmitted from the vehicle speed sensor 74 to the acceleration predictor 52.

Furthermore, the current value of the acceleration is transmitted from the acceleration sensor 75 to the acceleration predictor 52. The acceleration sensor 75 is capable of detecting acceleration of three components perpendicular to FR axial direction, WR axial direction, and UP axial direction, for example.

The navigation ECU 60 comprises a computer. For example, the navigation ECU includes input/output controller, CPU, RAM, ROM, and storage devices, similar to those illustrated in FIG. 4.

CPU executes the control program stored in the storage device or ROM. As a result, the navigation ECU 60 is configured with functional blocks as illustrated in FIG. 3. That is, the navigation ECU 60 comprises a map data processor 62 and a map data storage device 64.

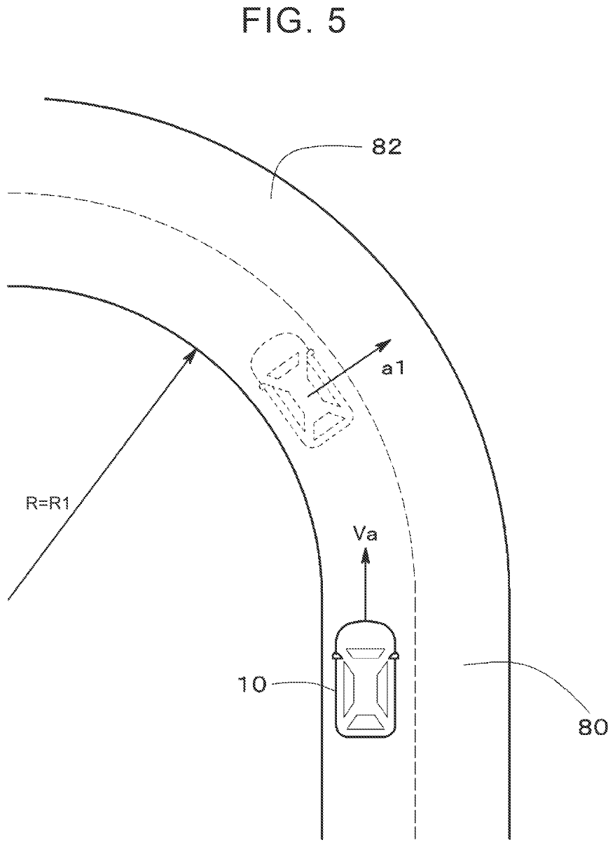

The map data storage device 64 stores road map data. The roadmap includes the roadway curve radius R (see FIG. 5) and the altitude. The curve radius R is used for acceleration prediction described later. Further, the uneven structure of the road can be grasped from the altitude data of the road. That is, when passing through the uneven portion of the road, the vertical acceleration generated in the vehicle 10 can be predicted.

The map data processor 62 sets the travel route of the vehicle 10 on the map data. For example, the destination of the vehicle 10 is inputted to the navigation ECU 60 by the driver or the like. The map data processor 62 calculates a route from the current value of the vehicle to the destination. The calculated travel route is set on the map data.

The positioning device 76 acquires the position of the vehicle 10. The positioning device 76 is, for example, a receiver of a satellite-positioning-system (Global Navigation Satellite System). The current position information of the vehicle 10 is transmitted to the map data processor 62.

In the map data, the current position of the vehicle 10 is set on the travel route. As a result, road information in front of the vehicle 10 along the traveling route is obtained. The road information includes the above-described curve radius R and the uneven state. Based on the road information, the acceleration predictor 52 predicts acceleration occurring in the vehicle 10.

### Attitude Control of Reservoir Tank

The acceleration predictor 52 calculates (predicts) an acceleration vector generated in the vehicle 10 after a predetermined time. For example, the acceleration predictor 52 calculates an acceleration vector generated in the vehicle 10 after one second. As described below, the acceleration predictor 52 predicts an acceleration vector generated in the vehicle 10 on the basis of the acceleration/deceleration operation for the vehicle 10, the vehicle speed of the vehicle 10, and the road information in front of the vehicle 10 along the traveling route.

Referring to FIG. 5, a curve 82 is disposed in front of the vehicle 10 traveling on the straight road 80. When the vehicle 10 travels on the curve 82, a so-called lateral G is generated in the vehicle 10. The lateral G indicates acceleration in the vehicle width direction.

The acceleration predictor 52 obtains the curved radial R1 of the curve 82 from the map-data. Furthermore, the acceleration predictor 52 acquires the actual vehicle speed Va from the vehicle speed sensor 74. The lateral G, that is, the vehicle-width-direction acceleration a1 is obtained from the following Equation (1).

a1=Va²/R1[m²/s](1)

Further, the acceleration predictor 52 acquires acceleration a0 in the gravitational direction (UP axial direction) from the acceleration sensor 75. Here, it is assumed that the gravitational acceleration a0 does not change between the present time and the predicted time.

The acceleration predictor 52 obtains the combined acceleration vector a2 from the acceleration vector a1 of the lateral G and the acceleration vector a0 of the gravitational direction, as illustrated in FIG. 6. The combined acceleration vector a2 indicates an acceleration vector generated in the vehicle 10 at a predicted time point (e.g., 1 second later).

The drive-signal generator 54 obtains the manipulated variable of the displacement device (the V-actuator 40 and the H-actuator 42) based on the combined acceleration-vector a2. That is, the drive-signal generator 54 obtains an angle θ_{H}1 between the combined acceleration vector a2 and UP axis. The angle θ_{H} corresponds to the displacement angle of the H actuator 42. Further, the drive-signal generator 54 obtains an angle θᵥ1 between the combined acceleration vector a2 and RW axis. The angle θᵥ corresponds to the displacement angle of the V-actuator 40. In FIG. 6, θᵥ1 is 0°.

In FIG. 2, the V-actuator 40 and the H-actuator 42 are illustrated in so-called original positions. At this time, the angle θᵥ of the V actuator 40 is 0°. Similarly, the angle θ_{H} of the H actuator 42 is 0°.

The drive signal generator 54 obtains the current angle θv0 of the V actuator 40 and the current angle θ_{H}0 of the H actuator 42 from an encoder (not shown). Further, the drive signal generator 54 obtains a difference Δθv between the current angle θᵥ0 and the predicted angle θᵥ1. The drive signal generator 54 obtains the difference Δθ_{H} between the current angle θ_{H}0 and the predicted angle θ_{H}1.

The drive signal generator 54 then generates a drive signal based on Δθᵥ and Δθ_{H}. A drive signal based on Δθᵥ is transmitted to the V actuator 40. A drive signal based on Δθ_{H} is transmitted to the H actuator 42.

The position of the reservoir tank 30 after the drive signal has been transmitted to the V actuator 40 and the H actuator 42 is illustrated in FIG. 7. In this example, because θᵥ=0°, the angular position of the V-actuator 40 is maintained in the original position. On the other hand, the angular position of the H actuator 42 is a position rotated clockwise from the original position.

Due to the displacement of the reservoir tank 30, the bottom wall 32 of the reservoir tank 30 is perpendicular to the acceleration vector a2 predicted by the acceleration predictor 52. Therefore, the liquid level of the coolant 36 on the bottom wall 32 is not biased, and the port 34 is covered with the coolant. As a result, the mixing of bubbles into the port 34 is suppressed.

FIG. 8 is a diagram illustrating an exemplary combination of acceleration vectors that differs from FIG. 6. In this example, in FIG. 5, an example is shown in which the brake pedal 70 of the vehicle 10 is depressed immediately before entering the curve 82 (see FIG. 3).

The acceleration predictor 52 calculates the lateral G, that is, the vehicle-width-direction acceleration a1, in the same manner as in FIG. 6. Further, the acceleration predictor 52 acquires acceleration a0 in the gravitational direction (UP axial direction) from the acceleration sensor 75.

Next, the acceleration predictor 52 acquires the depression amount of the brake pedal 70 from the brake sensor 71. Further, referring to FIG. 8, the acceleration predictor 52 obtains the deceleration acceleration a3 generated as a reaction of the deceleration based on the depression amount. Next, the acceleration predictor 52 obtains the combined acceleration vector a4 obtained by combining the acceleration vectors a0, a1, a3.

The drive-signal generator 54 determines an angle θ_{H}2 between the combined acceleration vector a4 and UP axis. Further, the drive-signal generator 54 obtains an angle θᵥ2 between the combined acceleration vector a4 and RW axis.

The drive signal generator 54 then obtains the current angle θᵥ0 of the V actuator 40 and the current angle θ_{H}0 of the H actuator 42 from an encoder (not shown). Further, the drive signal generator 54 obtains a difference 40v between the current angle θᵥ0 and the predicted angle θᵥ2. Further, the drive signal generator 54 obtains a difference Δθ_{H} between the current angle θ_{H}0 and the predicted angle θ_{H}2. The drive signal generator 54 then generates a drive signal based on Δθᵥ and Δθ_{H}. A drive signal based on Δθᵥ is transmitted to the V actuator 40. A drive signal based on Δθ_{H} is transmitted to the H actuator 42.

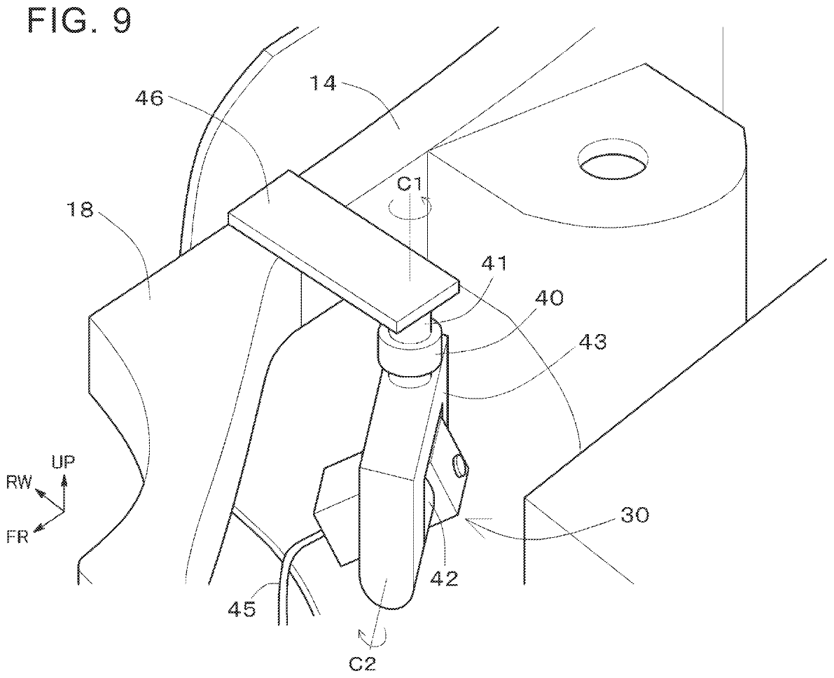

The V actuator 40 and the H actuator 42 displace the reservoir tank 30 as illustrated in FIG. 9. Due to this displacement, the bottom-wall 32 of the reservoir tank 30 is perpendicular to the acceleration vector a4 predicted by the acceleration predictor 52 (see FIG. 7). Therefore, the liquid level of the coolant 36 on the bottom wall 32 is not biased, and the port 34 is covered with the coolant. As a result, the mixing of bubbles into the port 34 is suppressed.

In the above description, so-called prediction control is executed as the attitude control of the reservoir tank 30. In addition, feedback control may be performed. For example, the acceleration predictor 52 may combine the predicted acceleration component with the actual acceleration component generated in the vehicle 10. Based on the combined acceleration vector, the operation amounts of the V actuator 40 and the H actuator 42 are obtained.

In the above-described embodiment, the displacement control of the reservoir tank 30 when the vehicle 10 travels on the curve 82 is exemplified, but the support mechanism according to the present embodiment is not limited to this configuration. For example, the acceleration predictor 52 may predict a so-called acceleration G due to depression of the accelerator pedal 72 (see FIG. 3). In addition, the acceleration predictor 52 may predict the acceleration caused by the push-up based on the uneven shape of the road surface ahead of the vehicle 10 in the traveling direction. In addition, acceleration due to these combinations may be predicted by the acceleration predictor 52. Based on the predicted acceleration and the resultant acceleration vector based on the gravitational acceleration, the drive signal generator 54 generates drive signals for the V actuator 40 and the H actuator 42.

Further, in the above-described embodiment, the V actuator 40 (first actuator) and the H actuator 42 (second actuator) are exemplified as displacement devices that make the attitude of the reservoir tank variable. However, the displacement device according to the present embodiment is not limited to this example. For example, the displacement device comprises an actuator having two orthogonal axes as rotation axes.

What is claimed is:

1. A support mechanism of a reservoir tank for a vehicle, the support mechanism comprising:
the reservoir tank in which a coolant is stored, and that is connected to a cooling circuit; and
a displacement device that is configured to vary an attitude of the reservoir tank.

2. The support mechanism according to claim 1, further comprising:
a map data processor that sets a travel route of the vehicle on map data;
a positioning device that acquires a position of the vehicle; and
a controller that controls the displacement device, wherein:
the controller includes an acceleration predictor;
the acceleration predictor is configured to predict an acceleration vector generated with respect to the vehicle, based on an acceleration or deceleration operation of the vehicle, a vehicle speed of the vehicle, and road information ahead of the vehicle along the travel route; and
the controller is further configured to find an operation amount of the displacement device based on the acceleration vector that is predicted.

3. The support mechanism according to claim 1, wherein the displacement device includes
a first actuator that is pivotable about a vertical axis, and
a second actuator that is pivotable about an axis orthogonal to the vertical axis.

4. The support mechanism according to claim 3, wherein:
a bottom wall of the reservoir tank is provided with a port that is an inlet and outlet of the coolant; and
the displacement device is configured to displace the attitude of the reservoir tank such that the acceleration vector that is predicted and the bottom wall of the reservoir tank are orthogonal.
